(19) United States
(12) Patent Application Publication
(10) Pub. No.: US 2014/0251310 A1
(43) Pub. Date: Sep. 11, 2014

(54) HIGH TEMPERATURE THERMAL ENERGY STORAGE

(71) Applicant: Abengoa Solar LLC, Lakewood, CO (US)

(72) Inventors: Russell Muren, Boulder, CO (US); Luke Erickson, Lakewood, CO (US); Gregory Shoukas, Lakewood, CO (US)

(21) Appl. No.: 14/352,044

(22) PCT Filed: Oct. 18, 2012
(86) PCT No.: PCT/US12/60823

§ 371 Date: Apr. 15, 2014

Related U.S. Application Data
(60) Provisional application No. 61/548,962, filed on Oct. 19, 2011.

(51) Int. Cl. F24J 2/34; B23P 15/26; F28D 1/02; F28D 20/02

(52) U.S. Cl. CPC F24J 2/34; F28D 20/021; B23P 15/26; F28D 1/02
USPC 126/618; 165/110; 165/104.17; 29/890.034; 165/157

(57) ABSTRACT

The effectiveness of heat transfer to and from a thermal energy storage medium, for example a phase change medium, is enhanced by the inclusion of thermally-conductive elements within the thermal energy storage medium. The thermally-conductive elements may be filler shapes placed in a self-supporting stacking arrangement, which may be a random stacking arrangement. The effective thermal conductivity of the matrix that includes the thermal energy storage medium and the thermally-conductive elements is higher than the thermal conductivity of the thermal energy storage medium itself. Other thermally-conductive elements may be used, for example thermally-conductive sheets.

This application claims priority to provisional U.S. Patent Application No. 61/548,962, filed Oct. 19, 2011 and titled “High Temperature Thermal Energy Storage”, the entire disclosure of which is hereby incorporated by reference herein for all purposes.

### STATEMENT REGARDING FEDERALLY SPONSORED RESEARCH OR DEVELOPMENT

This invention was made with government support under contract GO18156 awarded by the United States Department of Energy. The Government of the United States of America may have certain rights in the invention.

### BACKGROUND

Solar electric power generation systems often include thermal energy storage, to at least partially decouple the generation of electric power from the rate of incoming solar radiation. For example, in a typical installation in the desert southwest of the United States, incoming solar radiation may be at its peak near mid-day, but demand for electric power may peak in the late afternoon, and strong demand may continue into the evening and early nighttime hours. The time of power generation is typically dependent on the time at which incoming solar radiation is available. Many systems use a heat transfer fluid heated by solar collectors to provide thermal energy to a storage medium, and then extract thermal energy from the storage medium and provide it to a power generation block. Thermal energy may be provided to the storage medium during any time when sufficient solar radiation is being received, and may be extracted later for electric power generation, for example when demand for electric power is greatest, or at night when no solar radiation is available. Greater efficiencies in storing thermal energy are desired.

### SUMMARY

According to one aspect, a thermal storage element includes a container configured to contain a thermal energy storage medium, and a heat exchanger within the container and configured for circulation of a heat transfer fluid through the heat exchanger to exchange thermal energy with the thermal energy storage medium. The heat exchanger further includes a plurality of heat exchanger plates, and the thermal storage element further includes a plurality of thermally-conductive elements disposed within the container and positioned to be at least partially submerged by the thermal energy storage medium. At least some of the thermally-conductive elements are disposed between adjacent heat exchanger plates. In some embodiments, the thermally-conductive elements are thermally-conductive filler shapes disposed in a self-supporting stacking arrangement. The self-supporting stacking arrangement may be a self-supporting random stacking arrangement. In some embodiments, the thermally-conductive elements are thermally-conductive sheets. At least one of the thermally-conductive sheets may define openings through the sheet. At least some of the thermally-conductive sheets may be disposed transversely to the heat exchanger plates. In some embodiments, at least one of the thermally-conductive sheets does not touch any of the heat exchanger plates. In some embodiments, the thermal storage element further includes the thermal energy storage medium contained in the container. The thermal energy storage medium may be a phase change medium. In some embodiments, the thermal storage element further includes an inlet positioned to receive an inflow of the heat transfer fluid, and an outlet positioned to carry the heat transfer fluid from the thermal storage element. The thermally-conductive elements may have a void fraction of at least 90 percent. The thermally-conductive elements may have a void fraction of at least 95 percent. The thermally-conductive elements may have a void fraction of at least 98 percent. In some embodiments, the thermally-conductive elements comprise a metal. The thermally-conductive elements may comprise aluminum. The thermally-conductive elements may comprise stainless steel. The thermally-conductive elements may comprise expanded metal. The thermally-conductive elements may be coated to inhibit corrosion. The thermally-conductive elements may be made at least in part from scrap material. In some embodiments, a first one of the thermally-conductive elements is made of a first material, a second one of the thermally-conductive elements is made of a second material, and the first and second materials are different. In some embodiments, a first one of the thermally-conductive elements is of a first configuration, a second one of the thermally-conductive elements is of a second configuration, and the first and second configurations are different.

According to another aspect, a method of making a thermal storage element includes placing a heat exchanger within a container configured to contain a thermal energy storage medium. The heat exchanger includes a plurality of heat exchanger plates. The method further includes disposing a plurality of thermally-conductive elements within the container, at least some of the thermally-conductive elements being disposed between adjacent heat exchanger plates. In some embodiments, disposing the plurality of thermally-conductive elements within the container includes disposing a plurality of filler shapes in a self-supporting stacking arrangement. In some embodiments, disposing the plurality of thermally-conductive elements within the container includes disposing thermally-conductive sheets transverse to the heat exchanger plates. The method may further include at least partially submerging the plurality of filler shapes in the thermal energy storage medium within the container. In some embodiments, the thermal energy storage medium is a phase change medium, and the method further includes allowing the thermal energy storage medium to cool, transforming at least some of the thermal energy storage medium from a liquid state to a solid state.

According to another aspect, a solar power plant includes a circulating heat transfer fluid that is heated using solar radiation collected by the solar power plant, and a thermal storage element comprising a thermal energy storage medium and a heat exchanger that includes a plurality of heat exchanger plates. The heat transfer fluid circulates through the heat exchanger to provide thermal energy to the thermal energy storage medium via the heat exchanger. The solar power plant further includes a plurality of thermally-conductive elements disposed within the thermal energy storage medium, at least some of the thermally-conductive elements being disposed between adjacent heat exchanger plates. In some embodiments, the thermally-conductive elements are filler shapes disposed in a self-supporting stacking arrangement. In some embodiments, the thermally-conductive elements are thermally-conductive sheets. In some embodiments, the solar power plant further includes a field of solar collectors through which the heat transfer fluid circulates to be heated by solar radiation. In some embodiments, the solar power plant further includes a power tower through which the heat transfer fluid circulates to be heated by solar radiation.

In another aspect, a thermal storage element includes a container configured to contain a thermal energy storage medium, and a plurality of thermally-conductive filler shapes disposed within the container in a self-supporting stacking arrangement. The self-supporting stacking arrangement may be a self-supporting random stacking arrangement. In some embodiments, the thermal storage element further includes the thermal energy storage medium within the container, at least partially submerging the thermally-conductive filler shapes. In some embodiments, the thermal storage element further includes a heat exchanger within the container and configured for circulation of a heat transfer fluid through the heat exchanger to exchange thermal energy with the thermal energy storage medium, wherein the heat exchanger further comprises a plurality of heat exchanger plates, and wherein at least some of the thermally-conductive filler shapes are disposed between adjacent heat exchanger plates.

### BRIEF DESCRIPTION OF THE DRAWINGS

FIG. 1 illustrates a simplified schematic diagram of a solar electric power plant, in which embodiments of the invention may find utility.

FIG. 2 illustrates a cutaway view of an embodiment of a thermal storage element, in an early stage of construction.

FIG. 3 illustrates a cross section view of the example thermal storage element of FIG. 2.

FIG. 4 illustrates a technique in accordance with embodiments for enhancing the performance of the thermal storage element of FIG. 2.

FIG. 5 illustrates the thermal storage element of FIG. 4, after a thermal energy storage medium is added.

FIGS. 6A-6F illustrate several example configurations that may be used for filler shapes in accordance with embodiments.

FIG. 7 illustrates a cutaway view of a thermal storage element according to another embodiment, in an early stage of construction.

FIG. 8 shows a sectional view of the thermal storage element of FIG. 7.

FIG. 9 shows the thermal storage element of FIG. 7, after a thermal energy storage medium is added.

### DETAILED DESCRIPTION

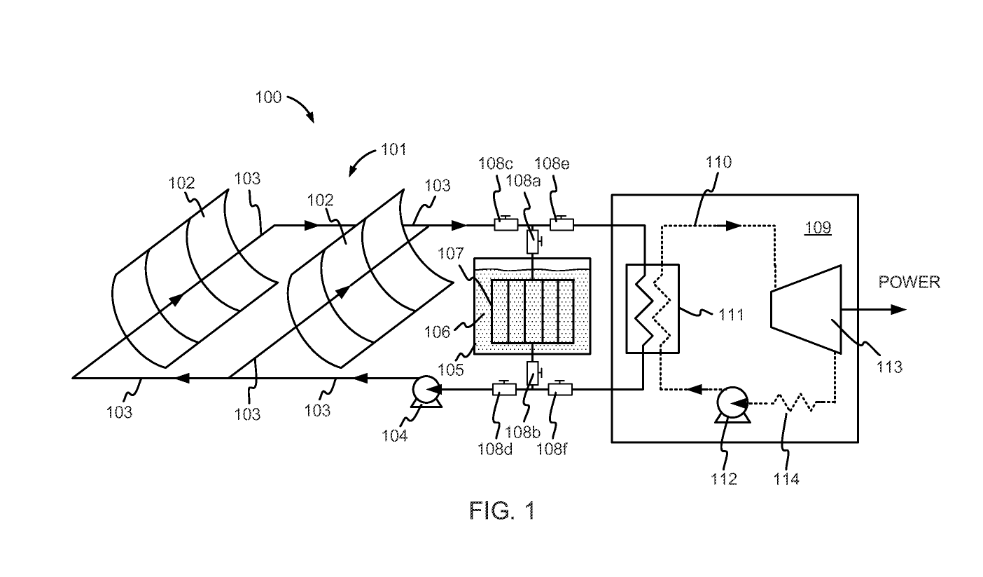

FIG. 1 illustrates a simplified schematic diagram of a solar electric power plant 100, in which embodiments of the invention may find utility. The solar electric power plant 100 includes a field 101 of solar collectors 102. For example, the solar collectors 102 may be parabolic though concentrating collectors that track the sun throughout the day, may be nonimaging collectors, or may be collectors of another kind. Not all of the collectors 102 need be of the same type. Rather, the field 101 may contain solar collectors of different types. It will also be recognized that embodiments of the invention may be used in a solar “power tower” arrangement.

A heat transfer fluid 103 circulates through the field 101 of collectors 102, driven by one or more pumps 104, and is heated by solar radiation gathered by the collectors 102. While only two collectors 102 are shown in FIG. 1 for illustration, embodiments of the invention may be used in systems with more or fewer collectors, for example in a large electric power generation system that includes thousands or tens of thousands of solar collectors 102. The solar collectors 102 may be arranged in a combination of series and parallel connections, so that not all of the heat transfer fluid 103 passes through every collector 102. Examples of heat transfer fluids that may be used for the heat transfer fluid 103 include a 73.5% diphenyl oxide (DPO) and 26.5% biphenyl eutectic mixture such as Therminol-VP1, available commercially from Solutia, Inc. of St. Louis, Mo., USA, or a dimethyl polysiloxane fluid such as Syltherm 800, available from Dow Corning Corporation of Midland, Mich., USA, although other fluids may be used.

The example solar electric power plant 100 also includes a thermal storage element 105, which contains a thermal energy storage medium 106 and a heat exchanger 107. A set of valves 108a-f can be configured to control the flow of the heat transfer fluid 103. In some embodiments, multiple thermal storage elements 105 may be used, for example with each thermal storage element 105 holding a different thermal energy storage medium 106 at a different temperature. Embodiments of the invention may be used in systems having multiple thermal storage elements 105.

A power generation block 109 generates electric power using thermal energy extracted from a working fluid 110. The working fluid 110 is heated using thermal energy from the heat transfer fluid 103 via a power block heat exchanger 111, and is circulated through a loop driven by one or more pumps 112. The working fluid 110 is circulated through the loop in the direction indicated by the arrows in FIG. 1. The working fluid 110 may comprise, for example, water that is heated to a vapor state such as steam, by passing the water through the power block heat exchanger 111, thereby extracting thermal energy from the heat transfer fluid 103 and heating the fluid to steam. The steam may then be used to turn a turbine 113, producing mechanical power that may be used to drive an electric generator (not shown). The steam is then condensed at a condenser 114, and circulated again by the pump 112 through the power block heat exchanger 111 to be re-heated. Some power loops may comprise multiple turbines and multiple steam extractions in order to increase the efficiency of the power generation system. While the illustrated system uses a steam-based Rankine cycle for power generation, other power cycles may be used in other embodiments. For example, a gas-based Brayton cycle may be used, or another kind of cycle.

In one mode of operation, with respect to controlling the flow of the heat transfer fluid 103, the valves 108a and 108b may be closed, and the valves 108c-f may be opened, so that the heat transfer fluid 103 circulates between the field 101 of the solar collectors 102 and the power block heat exchanger 111, bypassing the thermal storage element 105. This configuration may be used, for example, when it is desired to use all available solar energy for immediate electric power generation. In this mode, the heat transfer fluid 103 is heated in the solar collectors 102, thermal energy from the heat transfer fluid 103 is extracted by the power block heat exchanger 111 to heat the working fluid 110 for electric power generation, and the heat transfer fluid 103 is returned to the solar collectors 102 to be re-heated.

In another mode of operation, the valves 108a-f may be configured so that some or all of the flow of the heat transfer fluid 103 also circulates through the thermal storage element 105, which contains the thermal energy storage medium 106. This mode may be used, for example, when it is desired to heat the thermal energy storage medium 106 to enable later electric power generation and decouple the time of power generation from the time of receiving solar radiation. Thermal energy is transferred from the heat transfer fluid 103 to the thermal energy storage medium 106 via the heat exchanger 107. After the heat transfer fluid 103 has delivered some of its thermal energy to the thermal energy storage medium 106, it is then circulated again through the solar collectors 102, to be re-heated.

In a third mode of operation, the valves 108c and 108d may be closed, and the valves 108a, 108b, 108e, and 108f may be opened so that the heat transfer fluid 103 circulates only between the thermal storage element 105 and the power block heat exchanger 111. One or more additional pumps, not shown, may be used to drive the circulation of the heat transfer fluid. This mode may be used, for example, during inclement weather or at night when no solar radiation is being received, and when the thermal energy storage medium 106 holds sufficient thermal energy for power generation. In this mode, the heat transfer fluid 103 passes through the heat exchanger 107 to be heated by thermal energy extracted from the thermal energy storage medium 106, and then passes through the power block heat exchanger 111 to heat the working fluid 110 for electric power generation. The heat transfer fluid 103 then returns to the thermal storage element 105 to be re-heated.

The thermal energy storage medium 106 is preferably a substance with a high capacity for storage of thermal energy. In some embodiments, the thermal energy storage medium is a phase change medium that is held near its melting temperature, and stores thermal energy by virtue of the heat of transformation between its liquid and solid states, in addition to thermal energy stored in the medium by virtue of its temperature when in the solid or liquid state. At the melting temperature, the more thermal energy stored in the thermal storage element 105, the more of the phase change medium is liquid, and as thermal energy is extracted from the thermal storage element 105, the phase change medium re-freezes. In some embodiments, the thermal energy storage medium may be a solar salt, for example a mixture of sodium and potassium nitrates. Other thermal energy storage media may be used as well.

As will be appreciated, the performance of the solar electric power plant 100 depends in part on the effective transfer of thermal energy into, through, and out of the thermal energy storage medium 106. Because the thermal energy storage medium 106 may be stationary, as when a phase change medium is used, the transfer of thermal energy relies on conduction through the thermal energy storage medium 106. It is accordingly desirable for the thermal energy storage medium to have a relatively high thermal conductivity. However, some materials that have very high capacities for thermal energy storage, and are therefore desirable as thermal energy storage media for that reason, also have relatively poor thermal conductivity, which may limit the performance of a solar power generation system.

Prior approaches to improving thermal energy transfer have suffered drawbacks, for example high complexity and cost, susceptibility to corrosion, or inability to withstand the pressures and temperatures required in a power plant. Embodiments of the invention address these problems.

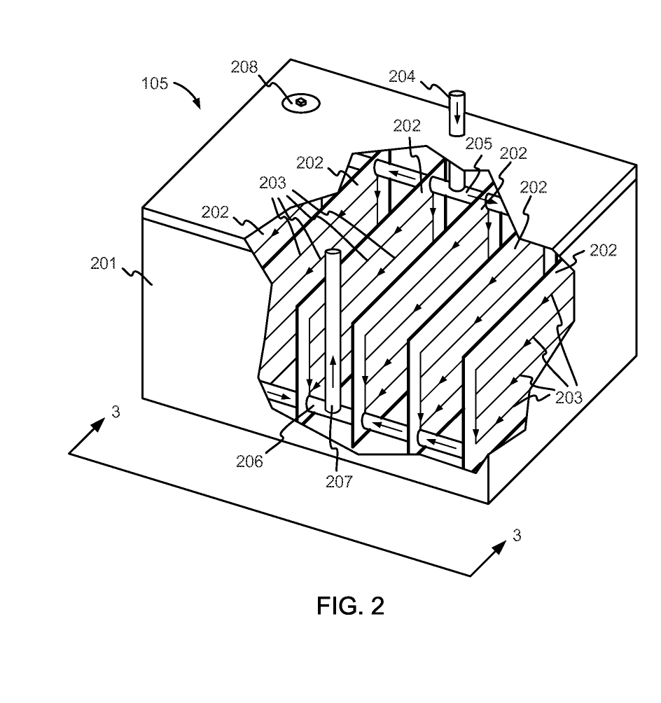

FIG. 2 illustrates a cutaway view of an embodiment of the thermal storage element 105. The thermal storage element 105 includes a container 201, which is preferably insulated. Although other heat exchanger types may be used, the example thermal storage element 105 uses a set of welded plates 202, each having channels 203 through which the heat transfer fluid 103 flows. The plate design exposes a large surface area of the plates to the thermal energy storage medium 106 when it is added to the container 201 at a later stage, to facilitate heat flow between the heat transfer fluid 103 and the thermal energy storage medium 106. Suitable plate heat exchangers may use, for example, Platecoil® heat exchanger components available from Tranter, Inc., of Wichita Falls, Tex., USA. The heat transfer fluid 103 may enter at an inlet 204, to be distributed to the plates 202 by a manifold 205. After passing through the plates 202, the heat transfer fluid 103 may be collected by an outlet manifold 206 and then flows to an outlet 207. For example, the inlet 204 may communicate with the valve 108a, and the outlet 207 may communicate with the valve 108b. The direction of flow may be reversed, if desired. An access opening 208 or other access to the interior of container 201 may be provided.

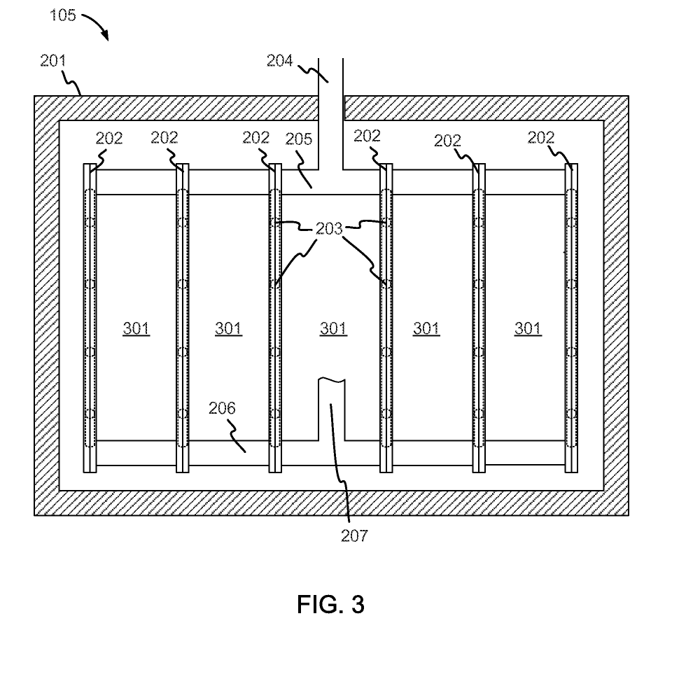

FIG. 3 illustrates a cross section view of the example thermal storage element 105, including spaces 301 between the welded plates 202, for holding the thermal energy storage medium 106.

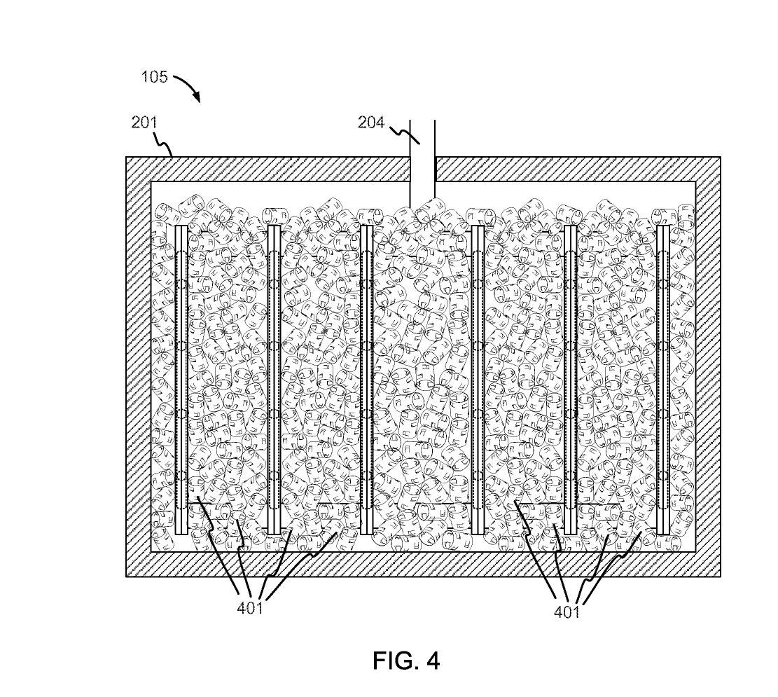

FIG. 4 illustrates a technique in accordance with embodiments for enhancing the performance of the thermal storage element 105, by supplementing the thermal conductivity of the thermal energy storage medium 106. Thermally-conductive filler shapes 401 are stacked within the container 201, preferably prior to the container 201 being sealed, or closed to the outside environment. The filler shapes 401 may be configured from any of a wide variety of materials or combinations of materials, for example metals, carbon or carbon composites, or any other material with a suitable strength and thermal conductivity. The filler shapes 401 may be made in any of a wide variety of configurations to provide desired properties, such as being self-supporting. The filler shapes 401 may not all be identical, but may include parts made in different configurations, and may include parts made of differing materials.

The filler shapes 401 are stacked in a self-supporting arrangement, and are preferably configured to be sufficiently strong to maintain their stacked height without undue crushing of the shapes at the bottom of the stack. In some embodiments, the filler shapes 401 may be stacked to a height of 10 meters or more.

The filler shapes 401 preferably have a large void fraction. For the purposes of this disclosure, the void fraction is the fraction of the space occupied by the filler shapes 401 that remains open, and is not taken up by the material of the filler shapes 401 themselves. For example, if the volume of the spaces 301 within the container 201 is 100 cubic meters, and the container is substantially filled with the filler shapes 401 having a void fraction of 98 percent, then 98 cubic meters of the spaces 301 would remain empty, and the material of the filler shapes 401 would consume only two cubic meters of the interior of the container 201, even though the filler shapes occupy nearly the entire container 201.

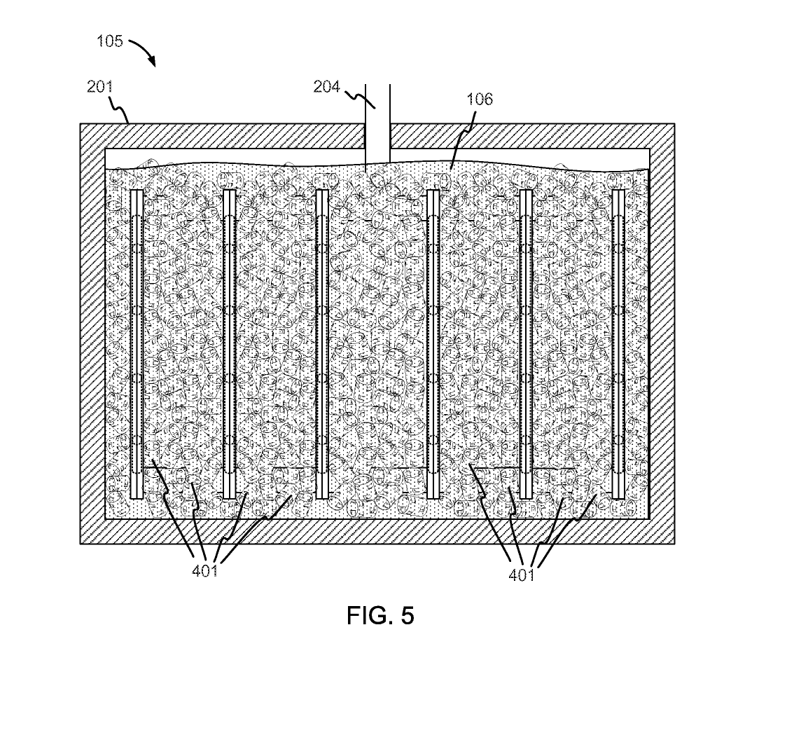

FIG. 5 illustrates the thermal storage element 105 after the thermal energy storage medium 106 is added, for example through the access opening 208. Because the filler shapes 401 have a high void fraction, the amount of the thermal energy storage medium 106 that can be contained within the thermal storage element 105 is nearly as large as if the filler shapes 401 were not present. The filler shapes 401 supplement the thermal conductivity of the thermal energy storage medium 106, enabling more effective transfer of thermal energy into and out of the thermal energy storage medium 106, and consequently improving the performance of a system such as the solar electric power plant 100 in which the thermal storage element 105 is used. The effective thermal conductivity of the matrix that includes the thermal energy storage medium 106 and the filler shapes 401 is higher than the thermal conductivity of the thermal energy storage medium 106 itself.

The self-supporting-stacking arrangement of the filler shapes 401 enables several efficiencies in the system. For example, no mounting structure need be constructed within the container 201, because the filler shapes 401 support themselves. Additionally, the filler shapes can vary in size and configuration, if desired, and may be stacked randomly within the container 201. It is to be understood that the invention is not so limited—the filler shapes 401 may be stacked in a regular arrangement, if desired. The thermal energy storage medium 106 can be simply poured over the stacked filler shapes 401 to engulf them. If a phase change medium is used, it would be heated to a liquid state for pouring, and then may be allowed to solidify around the filler shapes 401. Because the filler shapes 401 are self-supporting, they will maintain their positions even when the phase change medium melts during operation of the system. Preferably, the filler shapes 401 are shaped such that few air bubbles can form within them, so that little of the thermal energy storage medium 106 is displaced by air.

The thermal storage element 105 may be produced in any suitable order, and need not all be produced or assembled at the same time or location. For example, the thermal storage element 105 may be assembled at the installation site such as the solar electric power plant 100, from components shipped to the installation site. Alternatively, various subassemblies may be assembled remotely and shipped to the installation site. For example, the container 201 and the heat exchanger 107 may be fabricated remotely, shipped to the installation site, and combined there. The filler shapes 401 may be added at any workable time, for example through the access opening 208, or before a top of the thermal storage element 105 is put in place. The filler shapes 401 may be added at a remote production site or at the installation site. Similarly, the thermal energy storage medium 106 may be added at any workable time, but may preferably be added at the installation site.

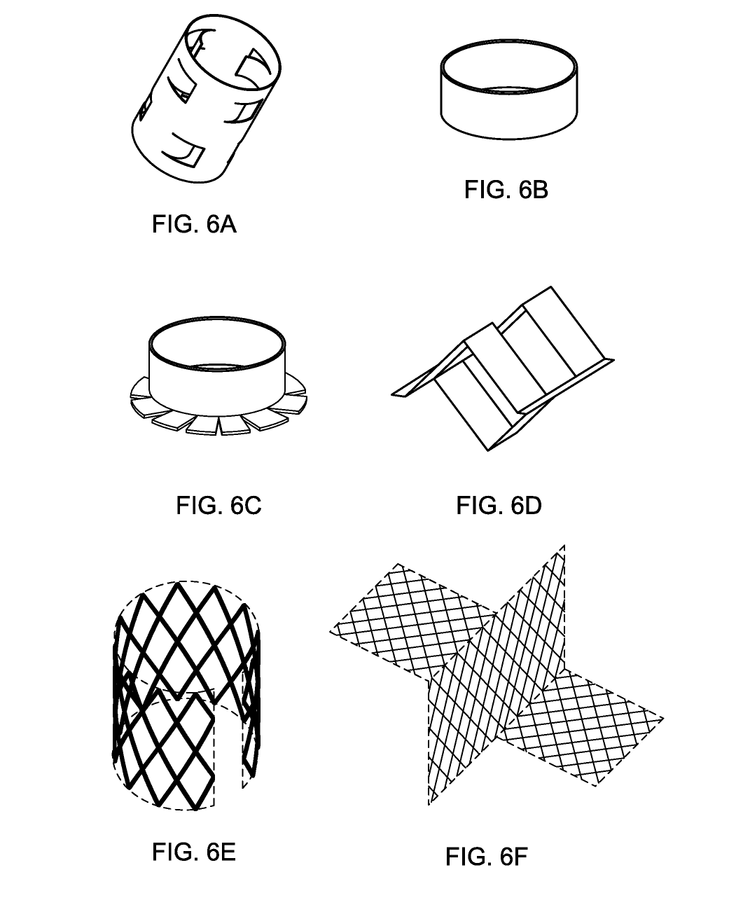

FIGS. 6A-6F illustrate several example configurations that may be used for the filler shapes 401, but it will be recognized that there are a nearly infinite number of possible configurations. The configurations shown in FIGS. 6A-6D are easily stamped from thin-walled metal tubing or sheet metal stock, but other material sources may be used. For example, the filler shapes 401 could be made from scrap materials such as scrap aluminum briquettes that are produced when scrap aluminum is compressed into briquettes at an aluminum forming factory. Other sources include machining scrap, or discarded aluminum cans, possibly modified to enable free flow of the thermal energy storage medium 106 through the cans.

In some embodiments, the filler shapes 401 may be made of lattice chips, for example aluminum lattice chips. Lattice chips are created by chipping sheet metal, for example mechanically expanded metal, hydraulically expanded metal, stamped metal sheet, or another kind low volume fraction metal sheet. The size and shape of the chips are not critical, but in one embodiment, the chips may be one to two centimeters square.

The filler shapes 401 may be formed of expanded metal, as illustrated in FIGS. 6E and 6F. In some embodiments, the expanded metal may be expanded aluminum. Expanded metal may be made in different ways, but in one process, a solid sheet of metal is perforated and stretched, forming a larger sheet of a screen-like lattice, having openings bounded by a network of relatively thin metal strips of the original sheet. Expanded metal thus has a relatively large void fraction as compared with the original solid sheet. While simple flat pieces of expanded metal may be used as the filler shapes, expanded metal may also be further worked in a manner similar to sheet metal, for example bent or folded into three-dimensional shapes. The shapes illustrated in FIGS. 6A-6F are intended to avoid nesting when the filler shapes are stacked in a self-supporting stacking arrangement, so that a high void fraction results.

In some embodiments, the filler shapes 401 are made of a metal or other material that has a thermal conductivity significantly higher than that of the thermal energy storage medium 106. In some embodiments, the material of the filler shapes 401 has a thermal conductivity at least twice that of the thermal energy storage medium 106. Preferably, the thermal conductivity of the material used for making the filler shapes 401 has a thermal conductivity of at least 4 W/m-K, and more preferably at least 10 W/m-K. In some embodiments, the filler shapes 401 may be made of steel, aluminum, copper, stainless steel, nickel, brass, bronze, silver, silicon carbide, or other materials, or combinations of materials. Aluminum and aluminum alloys are considered to be materials that are satisfactory for many embodiments, and have a thermal conductivity of about 250 W/m-K.

Some corrosion of the filler shapes 401 is to be expected, due to the contact of the filler shapes 401 with the thermal energy storage medium 106. The filler shapes 401 may be made of materials and may have dimensions that are selected so that the amount of corrosion occurring over the expected working life of the system is tolerated with little or no loss of performance. The required dimensions will depend somewhat on the particular material used for the filler shapes 401 and on the particular thermal energy storage medium 106 used, but in some embodiments, the filler shapes 401 are made of aluminum or an aluminum alloy, and have wall thicknesses between 0.1 millimeters and 2.0 millimeters, and preferably between 0.3 millimeters and 1.5 millimeters. The overall dimensions of the filler shapes 401 may vary, but in some embodiments, filler shapes having largest dimensions of about one centimeter to about 20 centimeters may be used. In other embodiments, the filler shapes 401 may have largest dimensions between 3 and 10 centimeters.

In some embodiments, the basic material of the filler shapes 401 may be protected from direct contact with the thermal energy storage medium 106, for example by plating or otherwise coating the filler shapes 401 in a way that inhibits corrosion. This may enable use of thinner materials as compared with installations wherein the filler shapes are not coated, as less sacrificial degradation of the filler shape material would be expected over the useful life of the thermal storage element 105.

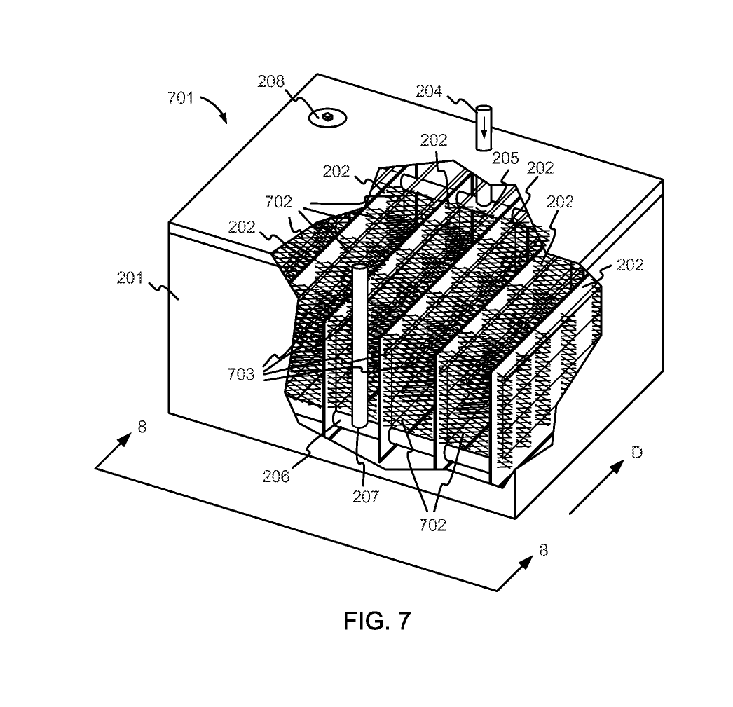

FIG. 7 illustrates a cutaway view of a thermal storage element 701 according to another embodiment, in an early stage of construction. Rather than stacked shapes as in the thermal storage element 105, the thermal storage element 701 uses a different kind of thermally-conductive elements to enhance the thermal conductivity of the thermal energy storage medium 106 within container 201. In the thermal storage element 701, the thermally-conductive elements are thermally-conductive sheets 702. The thermally-conductive sheets 702 may be made of, for example, aluminum, carbon steel, stainless steel, a carbon matrix, or another suitable material. As in the embodiment of FIG. 6, to be “thermally conductive” means that the thermally-conductive sheets 702 are made of a material or materials having a thermal conductivity significantly higher than that of the thermal energy storage medium 106, for example at least twice the thermal conductivity of the thermal energy storage medium 106 or more. In some embodiments, the thermal conductivity of the material used is between about 4 W/m-K and about 250 W/m-K or more. While the thermally-conductive sheets 702 are illustrated as being rectangular and flat, other suitable shapes may be used, depending on the shape of the container 201 and other factors.

Although not a requirement, in many embodiments, the sheets are perforated or otherwise formed with openings. For example, the thermally-conductive sheets 702 may be made of expanded metal, perforated sheet material, screen, a woven or welded mesh, wire, or another suitable material. The thermally-conductive sheets may be of any suitable thickness, for example about 0.05 inches to about 0.25 inches, although other thicknesses may be used.

In some embodiments, the basic material of the thermally-conductive sheets 702 may be protected from direct contact with the thermal energy storage medium 106, for example by plating or otherwise coating the thermally-conductive sheets 702 in a way that inhibits corrosion. This may enable use of thinner materials as compared with installations wherein the thermally-conductive sheets are not coated, as less sacrificial degradation of the sheet material would be expected over the useful life of the thermal storage element 105.

The thermally-conductive sheets 702 may be mounted in any suitable way, for example by hanging them from a structure 703 within the container 201, as shown in FIG. 7. In some installations, the mounting for the thermally-conductive sheets 702 may be conveniently integrated with a structure that also mounts the heat exchanger plates 202 (but is not shown in FIG. 7). The thermally-conductive sheets 702 may also be held in spaced-apart relating or supported at other locations along their length. For example, the bottom ends of the thermally-conductive sheets 702 may be fixed to the bottom of the container 201 or otherwise immobilized. In some embodiments, the thermally-conductive sheets 702 may be weighted at their bottom ends.

The thermally-conductive sheets 702 are preferably arranged transverse to the heat exchanger plates 202, so as to efficiently conduct heat from the thermal energy storage medium 106 toward the heat exchanger plates 202. The thermally-conductive sheets may be spaced apart (in direction “D” shown in FIG. 7) by any suitable distance, which may be selected for good performance and cost, while maintaining a large void fraction in the interior of the container 201. In some embodiments, the thermally-conductive sheets 702 may be spaced apart by a distance of about ½ inch to about 3 inches, or another suitable spacing. The thermally-conductive sheets 702 may but need not be uniformly spaced.

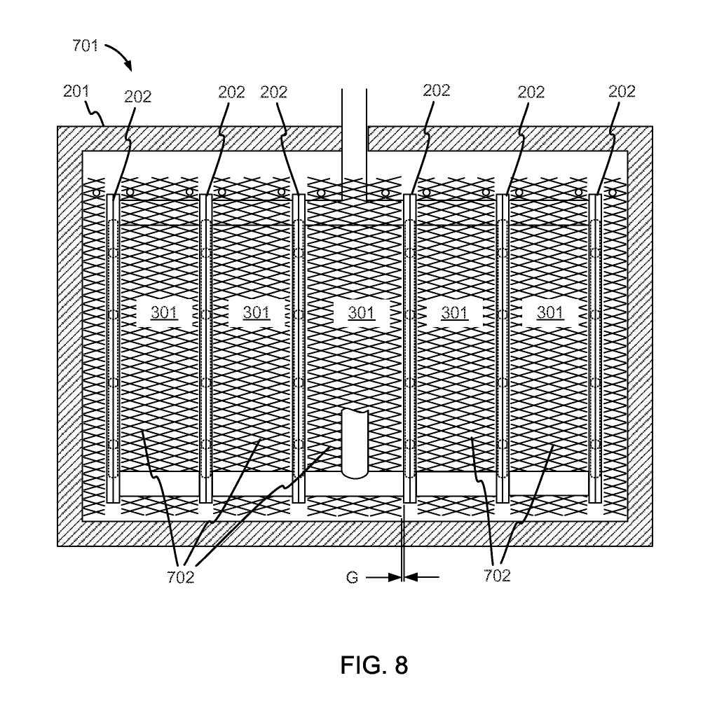

FIG. 8 shows a sectional view of the thermal storage element 701, showing the thermally-conductive sheets 702 suspended within the spaces 301 between the heat exchanger plates 202. The thermally-conductive sheets 702 may encroach as close as is practicable to the heat exchanger plates 202. For example, a typical gap distance G between the thermally-conductive sheets 702 and the heat exchanger plates 202 may be as small as about ¼ inch, depending on the size of the system and the accuracy with which the various components can be manufactured and assembled. In some embodiments, the thermally-conductive sheets 702 may not touch the heat exchanger plates 202.

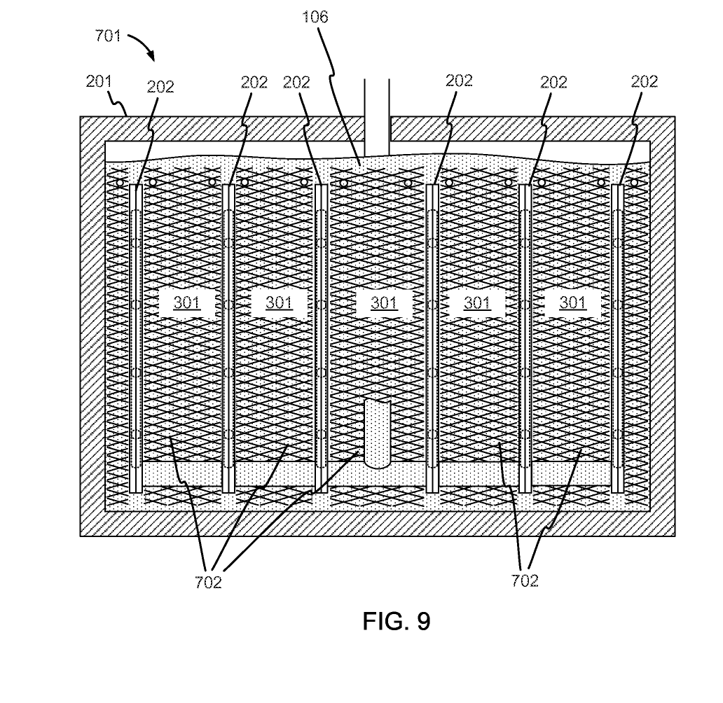

FIG. 9 shows a sectional view of the thermal storage element 701, with the thermal energy storage medium 106 in place. Preferably, the heat exchanger plates 202 and the thermally-conductive sheets 702 are completely or substantially submerged in the thermal energy storage medium 106.

The present invention has been described above in terms of presently preferred embodiments so that an understanding of the present invention can be conveyed. There are, however, many configurations for thermal storage elements not specifically described herein but with which the present invention is applicable. The present invention should therefore not be seen as limited to the particular embodiments described herein, but rather, it should be understood that the present invention has wide applicability with respect to thermal storage systems generally. All modifications, variations, or equivalent arrangements and implementations that are within the scope of the attached claims should therefore be considered within the scope of the invention.

What is claimed is:

1. A thermal storage element, comprising:
a container configured to contain a thermal energy storage medium;
a heat exchanger within the container and configured for circulation of a heat transfer fluid through the heat exchanger to exchange thermal energy with the thermal energy storage medium, wherein the heat exchanger further comprises a plurality of heat exchanger plates; and
a plurality of thermally-conductive elements disposed within the container and positioned to be at least partially submerged by the thermal energy storage medium, wherein the thermally-conductive elements are thermally-conductive filler shapes disposed in a self-supporting stacking arrangement and at least some of the thermally-conductive filler shapes are disposed between adjacent heat exchanger plates.

2. (canceled)

3. The thermal storage element of claim 1, wherein the self-supporting stacking arrangement is a self-supporting random stacking arrangement.

4. (canceled)

5. (canceled)

6. (canceled)

7. (canceled)

8. The thermal storage element of claim 1, further comprising the thermal energy storage medium contained in the container.

9. The thermal storage element of claim 8, wherein the thermal energy storage medium is a phase change medium.

10. The thermal storage element of claim 1, further comprising:
an inlet positioned to receive an inflow of the heat transfer fluid; and
an outlet positioned to carry the heat transfer fluid from the thermal storage element.

11. The thermal storage element of claim 1, wherein the thermally-conductive elements have a void fraction of at least 90 percent.

12. The thermal storage element of claim 1, wherein the thermally-conductive elements have a void fraction of at least 95 percent.

13. The thermal storage element of claim 1, wherein the thermally-conductive elements have a void fraction of at least 98 percent.

14. The thermal storage element of claim 1, wherein the thermally-conductive elements comprise a metal.

15. The thermal storage element of claim 14, wherein the thermally-conductive elements comprise aluminum.

16. The thermal storage element of claim 14, wherein the thermally-conductive elements comprise stainless steel.

17. The thermal storage element of claim 14, wherein the thermally-conductive elements comprise expanded metal.

18. The thermal storage element of claim 14, wherein the thermally-conductive elements are coated to inhibit corrosion.

19. The thermal storage element of claim 1, wherein the thermally-conductive elements are made at least in part from scrap material.

20. The thermal storage element of claim 1, wherein:
a first one of the thermally-conductive elements is made of a first material;
a second one of the thermally-conductive elements is made of a second material; and
the first and second materials are different.

21. The thermal storage element of claim 1, wherein:
a first one of the thermally-conductive elements is of a first configuration;
a second one of the thermally-conductive elements is of a second configuration; and
the first and second configurations are different.

22. A method of making a thermal storage element, the method comprising:
placing a heat exchanger within a container configured to contain a thermal energy storage medium, the heat exchanger comprising a plurality of heat exchanger plates; and
disposing a plurality of thermally-conductive filler shapes in a self-supporting stacking arrangement within the container, at least some of the thermally-conductive filler shapes being disposed between adjacent heat exchanger plates.

23. (canceled)

24. (canceled)

25. The method of claim 22, further comprising at least partially submerging the plurality of filler shapes in the thermal energy storage medium within the container.

26. The method of claim 25, wherein the thermal energy storage medium is a phase change medium, and the method further comprises allowing the thermal energy storage medium to cool, transforming at least some or the thermal energy storage medium from a liquid state to a solid state.

27. A solar power plant, comprising:
a circulating heat transfer fluid that is heated using solar radiation collected by the solar power plant;
a thermal storage element comprising a thermal energy storage medium and a heat exchanger that includes a plurality of heat exchanger plates, wherein the heat transfer fluid circulates through the heat exchanger to provide thermal energy to the thermal energy storage medium via the heat exchanger; and
a plurality of thermally-conductive elements disposed within the thermal energy storage medium, at least some of the thermally-conductive elements being disposed between adjacent heat exchanger plates.

28. The solar power plant of claim 27, wherein the thermally-conductive elements are filler shapes disposed in a self-supporting stacking arrangement.

29. The solar power plant of claim 27, wherein the thermally-conductive elements are thermally-conductive sheets.

30. The solar power plant of claim 27, further comprising a field of solar collectors through which the heat transfer fluid circulates to be heated by solar radiation.

31. The solar power plant of claim 27, further comprising a power tower through which the heat transfer fluid circulates to be heated by solar radiation.

32. A thermal storage element, comprising:
a container configured to contain a thermal energy storage medium; and
a plurality of thermally-conductive filler shapes disposed within the container in a self-supporting stacking arrangement.

33. The thermal storage element of claim 32, wherein the self-supporting stacking arrangement is a self-supporting random stacking arrangement.

34. The thermal storage element of claim 32, further comprising the thermal energy storage medium within the container, at least partially submerging the thermally-conductive filler shapes.

35. The thermal storage element of claim 32, further comprising a heat exchanger within the container and configured for circulation of a heat transfer fluid through the heat exchanger to exchange thermal energy with the thermal energy storage medium, wherein the heat exchanger further comprises a plurality of heat exchanger plates, and wherein at least some of the thermally-conductive filler shapes are disposed between adjacent heat exchanger plates.
